(19) United States
(12) Patent Application Publication
(10) Pub. No.: US 2025/0167252 A1
(43) Pub. Date: May 22, 2025

(54) MANUFACTURING METHOD OF CATALYST FOR MEMBRANE-ELECTRODE ASSEMBLY

(71) Applicant: SAMSUNG ELECTRO-MECHANICS CO., LTD., Suwon-si (KR)

(72) Inventors: Guh Hwan LIM, Suwon-si (KR); Byung Chul JANG, Suwon-si (KR); Sun II JEONG, Suwon-si (KR); Hae Sol JUNG, Suwon-si (KR); Tae Jun CHOI, Suwon-si (KR)

(73) Assignee: SAMSUNG ELECTRO-MECHANICS CO., LTD., Suwon-si (KR)

(21) Appl. No.: 18/923,981

(22) Filed: Oct. 23, 2024

(30) Foreign Application Priority Data
Nov. 16, 2023 (KR) 10-2023-0159215

(51) Int. Cl. H01M 4/92; C25B 9/23; C25B 11/032; C25B 11/081; H01M 4/86; H01M 8/10; H01M 8/1004

(52) U.S. Cl. CPC H01M 4/92; C25B 9/23; C25B 11/032; C25B 11/081; H01M 4/8626; H01M 8/1004; H01M 2008/1095

(57) ABSTRACT

Provided is a method of producing a catalyst for a membrane-electrode assembly, the method including: preparing a precursor solution including a catalyst metal; preparing a seed solution by maintaining the precursor solution at a temperature within a first temperature range, lower than room temperature; maintaining the seed solution at a temperature within a second temperature range, higher than the first temperature range; and heating the seed solution to a temperature within a third temperature range, higher than the second temperature range.

### CROSS-REFERENCE TO RELATED APPLICATION(S)

This application claims benefit of priority to Korean Patent Application No. 10-2023-0159215 filed on Nov. 16, 2023 in the Korean Intellectual Property Office, the disclosure of which is incorporated herein by reference in its entirety.

### TECHNICAL FIELD

The present disclosure relates to a method of producing a catalyst for a membrane-electrode assembly.

A polymer electrolyte membrane fuel cell and a polymer electrolyte membrane water electrolysis cell are eco-friendly energy source devices using hydrogen and are attracting attention due to the high efficiency and capacity for miniaturization thereof. The polymer electrolyte membrane fuel cell and the polymer electrolyte membrane water electrolysis cell generally include a membrane-electrode assembly (MEA) in which a polymer electrolyte membrane is disposed between catalyst electrodes, and the performance of the membrane-electrode assembly greatly determines the performance of the polymer electrolyte membrane fuel cell or the polymer electrolyte membrane water electrolysis cell.

The catalyst electrodes used in the membrane-electrode assembly generally includes aggregates of catalyst particles, and if a surface area of these aggregates increases, an area available for reaction may increase. Methods are being researched to obtain catalyst particles which are small in size and which do not change significantly so that the aggregates of catalyst particles have a high surface area, but do not vary significantly, that is, have uniform sizes.

### SUMMARY

An aspect of the present disclosure is to implement a method of producing a catalyst for a membrane-electrode assembly that can obtain catalyst particles having a uniform size and fine size. However, the purpose of the present disclosure is not limited to the above-mentioned purpose and will be realized by means and combinations thereof described in the patent claims.

According to some aspects of the present disclosure, provided is a method of producing a catalyst for a membrane-electrode assembly through an example, specifically, the method including: preparing a precursor solution including a catalyst metal, preparing a seed solution by maintaining the precursor solution at a temperature within a first temperature range, lower than room temperature, maintaining the seed solution at a temperature within a second temperature range, higher than the first temperature range, and heating the seed solution to a temperature within a third temperature range, higher than the second temperature range.

In some embodiments, the precursor solution may include ions of the catalyst metal.

In some embodiments, the first temperature range may be 0° C. to 10° C.

In some embodiments, the maintaining the precursor solution in the first temperature range may include adding a reducing agent to the precursor solution.

In some embodiments, the reducing agent may include at least one of NaBH₄, ascorbic acid, and hydrazine.

In some embodiments, the adding a reducing agent to the precursor solution may include injecting the reducing agent into the precursor solution at an amount of 0.1 ml/min to 20 ml/min.

In some embodiments, the second temperature range may be 20° C. to 30° C.

In some embodiments, the maintaining the seed solution in the second temperature range may be performed for 1 hour to 72 hours.

In some embodiments, the third temperature range may be 40° C. to 120° C.

In some embodiments, in the heating the seed solution in the third temperature range, aggregates of nano-sized particles including the catalyst metal may be formed.

In some embodiments, the nano-sized particles may include an oxide of the catalyst metal.

In some embodiments, the nano-sized particles may include particles having a diameter of 1 to 3 nm.

In some embodiments, the catalyst metal may include at least one of Ir, Ru, Pt, Pd, and Au.

In some embodiments, the producing the precursor solution may include dispersing a support for supporting a catalyst in the precursor solution.

In some embodiments, the support may include at least one selected from the group consisting of Antimony Tin Oxide (ATO), Indium Tin Oxide (ITO), Fluorine doped Tin Oxide (FTO) TiO₂, Ti₃O₇, CeO₂, Carbon Black, Carbon Nanotube (CNT), Graphene flake, Graphene Oxide (GO), and Reduced Graphene Oxide (RGO) Ti₃O₇.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a process flow diagram illustrating a method of producing a catalyst for a membrane-electrode assembly according to an embodiment of the present disclosure.

FIGS. 2 and 3 are cross-sectional views illustrating an example of a catalyst for a membrane-electrode assembly.

FIG. 4 is a cross-sectional view schematically illustrating a membrane-electrode assembly according to an embodiment of the present disclosure.

FIG. 5 is an enlarged view of components of the membrane-electrode assembly.

FIG. 6 illustrates a membrane-electrode assembly according to a modified example.

FIG. 7 is an enlarged view of one region of a gas diffusion layer in the membrane-electrode assembly of FIG. 6.

### DETAILED DESCRIPTION

Hereinafter, some embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numerals are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

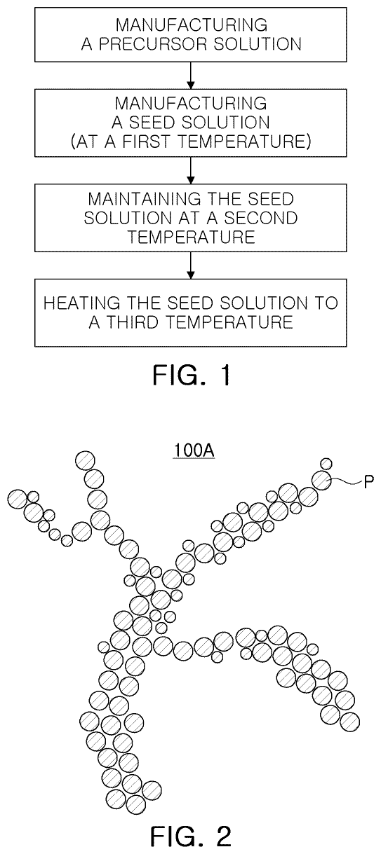

FIG. 1 is a process flow diagram illustrating a method of producing a catalyst for a membrane-electrode assembly according to an embodiment of the present disclosure. FIG. 2 is a cross-sectional view illustrating an example of a catalyst for a membrane-electrode assembly.

The method of producing a catalyst for a membrane-electrode assembly according to the present embodiment may include a method of synthesizing the catalyst in three different temperature ranges. Unlike conventional processes, since an organic stabilizer may not be used for catalyst synthesis in the present embodiment, not only does the organic stabilizer not need to be removed, but an activity of the catalyst can also be improved.

Specifically, the method of producing a catalyst for a membrane-electrode assembly according to the present embodiment may include the following operations:
(1) preparing a precursor solution including a catalyst metal;
(2) preparing a seed solution by maintaining the precursor solution at a temperature within a first temperature range lower than room temperature;
(3) maintaining the seed solution at a temperature within a second temperature range higher than the first temperature range; and
(4) heating the seed solution to a temperature within a third temperature range higher than the second temperature range.

Regarding the operation of preparing a precursor solution including the catalyst metal, the precursor solution may correspond to a raw material for producing a catalyst, and may be appropriately selected depending on the catalyst to be obtained. In this case, the precursor solution may include ions of the catalyst metal. As an example, the catalyst may include Ir-based, Ru-based, or Ir—Ru-based materials, and may also include Pt, Pd, Rh, Au, and the like. As a more specific example, when the catalyst is Ir, the precursor solution may be obtained by dissolving IrCl₃·nH₂O in ultrapure water (DI Water), and a stirring operation may be performed if necessary to facilitate dissolution. In addition, depending on the material constituting the catalyst, other precursor materials, such as RuCl₃·nH₂O (Ru precursor), H₂PtCl₆·nH₂O (Pt precursor), Na₂ PdCl₆·nH₂O (Pd precursor), HAuCl₄·nH₂O (Au precursor), and the like, may also be used. Furthermore, any metal precursor which is soluble in water, even if it is not necessarily a hydrate, can be used in this producing method. The precursor solution may exist in an ionic state of the catalyst metal, and depending on the type of precursor, the ionic state of the catalyst metal may exist in various forms such as M¹⁺, M²⁺, M³⁺, M⁴⁺, and the like.

Next, a seed solution is manufactured by maintaining the precursor solution at a temperature within a first temperature range lower than room temperature. In the present embodiment, the preparing the seed solution is performed at a temperature within a first temperature range lower than room temperature, where the first temperature range, lower than room temperature may be 0° C. to 10° C. The precursor solution may be disposed in an ice bath to maintain the precursor solution at a temperature within a range of 0° C. to 10° C. In the present operation, the ions of the catalyst metal present in the precursor solution may perform a reduction reaction by receiving electrons, and in this process, an ion valency of the ions of the catalyst metal is reduced by addition and becoming a seed for the catalyst. For example, when the catalyst metal exists in the form of M³⁺, it may be changed to M⁰. By allowing a reduction reaction to occur while maintaining the precursor solution in a relatively low temperature range, a size of the catalyst particles may be maintained fine and problems such as boiling over of the solution may also be prevented. In the present embodiment, the precursor solution was maintained at a relatively low temperature to allow the reduction reaction to proceed as slowly as possible.

As a method for increasing a yield of the catalyst by allowing the above-described reduction reaction to occur more smoothly, the maintaining the precursor solution in the first temperature range may include adding a reducing agent to the precursor solution. The reducing agent may cause a reduction reaction by providing electrons to the ions of the catalyst metal, whereby an ion valency of the ions of the catalyst metal is reduced by addition the reducing agent and becoming a seed for the catalyst. As a suitable material capable of playing this role as the reducing agent, the reducing agent may include at least one selected from the group consisting of NaBH₄, ascorbic acid, and hydrazine. In order to adjust a rate of the reduction reaction of the catalyst metal, the amount and rate of addition of the reducing agent may be adjusted. The amount and rate of injecting the reducing agent can also be adjusted to control the size of the catalyst particles. For example, the reducing agent may be injected into the precursor solution at an amount of 0.1 ml/min to 20 ml/min.

Next, the seed solution, that is, the precursor solution in which a reduction reaction occurred, is maintained at a temperature within a second temperature range which is higher than the first temperature range. Here, the second temperature range may be a room temperature range, and specifically, the second temperature range may be 20° C. to 30° C. For the present operation, the seed solution may be taken out of the ice bath and maintained at room temperature. This room temperature maintenance operation may be performed for 1 to 72 hours, and a stirring operation of the solution may be added during the process. While maintained in the second temperature range, the seed may aggregate and grow into a cluster, and the catalyst material thus generated may form a structure of oxide/hydrate by oxygen and water in an aqueous solution. In the present operation, rather than by performing a heat treatment at a high temperature immediately after the low-temperature section, and maintaining at room temperature in the middle before a relatively long time, a growth rate of the catalyst particles may be prevented from being too fast. This was adopted for the purpose of miniaturization and uniformity of the catalyst particles, the problem of unintentionally increasing the size of catalyst particles may be minimized.

Next, the seed solution is heated to a temperature within a third temperature range which is higher than the second temperature range. In the present operation, sufficient heat energy is supplied to cause aggregation between the catalyst clusters, thereby forming catalyst particles. In addition, catalyst materials present in the form of small seeds may also dissolve in a solution due to high thermal energy and contribute to the growth of catalyst particles. Here, the third temperature range may be 40° C. to 120° C. The oxide/hydroxide catalyst particles obtained in the present operation may have high crystallinity due to sufficient heat energy. As described above, in the operation of heating to the third temperature range, aggregates of nano-sized particles including the catalyst metal may be formed. In this case, the nano-sized particles may include an oxide of the catalyst metal, for example, IrO₂. In addition, the nano-sized particles may include particles having a diameter of 1 to 3 nm.

After this heat treatment operation, the reaction solution may be cleaned and purified, thereby obtaining a catalyst for a membrane-electrode assembly. FIG. 2 is a cross-sectional view illustrating an example of a catalyst obtained through this process. In a catalyst produced by three-step reactions having different temperature ranges as described above, as compared to a catalyst obtained by an organic solvent-based synthesis method using an organic stabilizer, there is no need to perform a cleaning process or an additional heat treatment process to remove the stabilizer on the surface, and there is no problem of deterioration in catalyst activity due to residual stabilizer. Referring to FIG. 2, the catalyst 100A may include approximately spherical and uniform sized nano-sized particles P, and do not use a stabilizer, so the particles P may aggregate with each other to form a network.

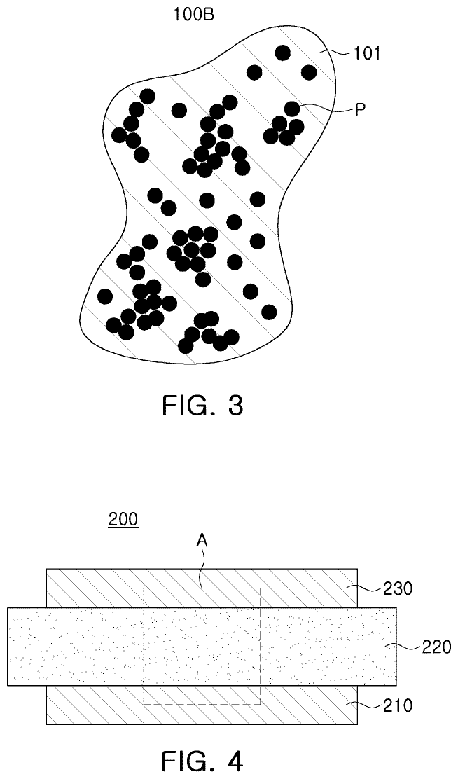

Meanwhile, the method of producing the catalyst described above may be used even when a support for supporting the catalyst is included. Specifically, the operation of preparing the precursor solution may include dispersing a support for supporting the catalyst in the precursor solution. Here, the support may include at least one selected from the group consisting of Antimony Tin Oxide (ATO), Indium Tin Oxide (ITO), Fluorine doped Tin Oxide (FTO), TiO₂, Ti₃O₇, CeO₂, Carbon Black, Carbon Nanotube (CNT), Graphene flake, Graphene Oxide (GO), and Reduced Graphene Oxide (RGO) Ti₃O₇. Even when a support is included, the catalyst can be manufactured through the three temperature ranges described above, and FIG. 3 illustrates catalyst particles P obtained by this method. As shown, the catalyst particles P may be obtained in a structure dispersed on a surface of the porous support 101

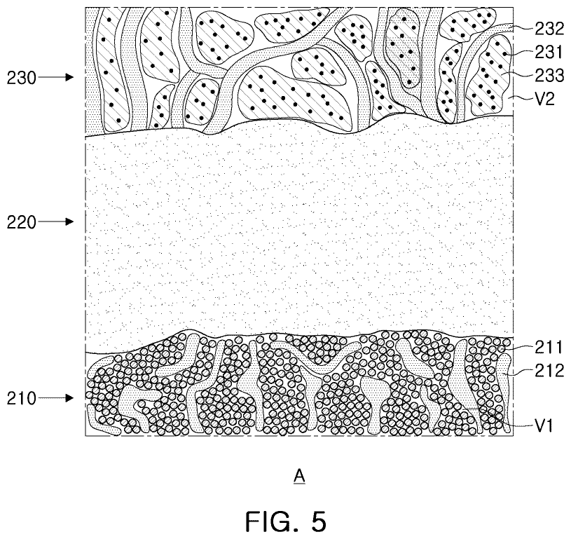

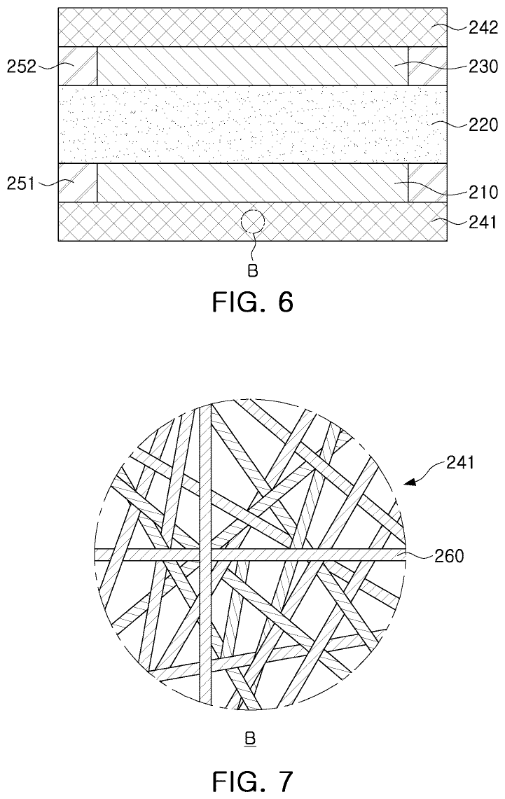

Hereinafter, a membrane-electrode assembly including a catalyst obtained by the above-described producing method will be described. FIG. 4 is a cross-sectional view schematically illustrating a membrane-electrode assembly according to some embodiments of the present disclosure, and FIG. 5 is an enlarged view of components of the membrane-electrode assembly. FIG. 6 illustrates a membrane-electrode assembly according to a modified example, and FIG. 7 is an enlarged view of one region B of a gas diffusion layer in the membrane-electrode assembly of FIG. 6.

Referring to FIGS. 4 and 5, the membrane-electrode assembly 200 according to some embodiments of the present disclosure includes a first catalyst electrode 210, a polymer electrolyte membrane 220, and a second catalyst electrode 230 as main components. Hereinafter, the components of the membrane-electrode assembly 200 will be described in detail, focusing on the case in which the membrane-electrode assembly 200 is a water electrolysis battery. However, the membrane-electrode assembly 200 may be used as a fuel cell, and in this case, an opposite reaction will occur. In this case, the opposite reaction will occur in the first catalyst electrode 210 and the second catalyst electrode 230 of the membrane-electrode assembly 200 as compared to when used as a water electrolysis cell.

The first catalyst electrode 210 may include a first catalyst 211, and may include aggregates of the first catalyst 211 particles as shown in FIG. 5. In addition to the first catalyst 211, the first catalyst electrode 210 may include an ion conductor 212, which may function as a binder for the first catalyst 211. In addition, pores V1 may be formed within the first catalyst electrode 210 to allow gas, liquid, and the like, to move smoothly. The first catalyst 211 is active in an oxygen generation reaction and may include an Ir-based, Ru-based, or Ti-based material. The ion conductor 212 may provide a movement path for hydrogen ions generated in the first catalyst electrode 210, and may include, for example, a fluorine-based ionomer, a carbon-hydrogen-based ionomer, or a mixture thereof. As a specific example, the ion conductor 212 may include a perfluorinated sulfonic acid ionomer. In a water electrolysis cell, the first catalyst electrode 210 is an anode, and the water supplied thereto may be separated into oxygen (O₂), hydrogen ions (H⁺, protons), and electrons. Here, the hydrogen ions may move to a second catalyst electrode 230 through the polymer electrolyte membrane 220, and in the electrons, the electrons may move to the second catalyst electrode 230 through an external circuit and a power supply.

The first catalyst 211 can be obtained through the above-described producing method, and catalyst particles may be aggregated to form a network. Since the first catalyst 211 may have high catalytic activity, the reaction efficiency of the first catalyst electrode 210 including the same may be improved. In addition, as shown in FIG. 3, the first catalyst 211 may be provided while being supported on a support.

The polymer electrolyte membrane 220 may include an ion conductor to provide a movement path for hydrogen ions, or the like. Here, the ion conductor of the polymer electrolyte membrane 220 may include, for example, a fluorine-based ionomer, a carbon-hydrogen-based ionomer, or a mixture thereof. As a specific example, the ion conductor 212 may include a perfluorinated sulfonic acid ionomer. In a water electrolysis cell, hydrogen ions generated in the first catalyst electrode 210 may move to the second catalyst electrode 230 through the polymer electrolyte membrane 220.

The second catalyst electrode 230 includes a second catalyst 231, and is disposed on the polymer electrolyte membrane 220. In this case, the second catalyst 231 may be provided in a form of being supported on a support 233, as illustrated in FIG. 5. In addition, the second catalyst electrode 230 may include an ion conductor 232, which may function as a binder between the second catalyst 231 and the support 233. In addition, pores V2 may be formed within the second catalyst electrode 230 to allow gas, liquid, and the like, to move smoothly. The second catalyst 231 is active in a hydrogen oxidation reaction or oxygen reduction reaction and includes at least one selected from the group consisting of platinum (Pt), gold (Au), ruthenium (Ru), osmium (Os), palladium (Pd), and alloys thereof. The ion conductor 232 may provide a path for movement of hydrogen ions, or the like, and may include, for example, a fluorine-based ionomer, a carbon-hydrogen-based ionomer, a mixture thereof, and the like. As a specific example, the ion conductor 232 may include a perfluorinated sulfonic acid ionomer. The support 233 may be formed of a porous material having a high surface area to support a large amount of the second catalyst 231. For example, a carbon-based support may be used. In a water electrolysis cell, the second catalyst electrode 230 is a cathode, and hydrogen ions supplied thereto through the polymer electrolyte membrane 220 can react with electrons to generate hydrogen.

Meanwhile, in the above description, the case in which the first catalyst electrode 210 and the second catalyst electrode 230 are an anode and a cathode, respectively, is used as an example, but a structure opposite thereto is also possible. That is, as a modified example, in the membrane-electrode assembly 200, the first catalyst electrode 210 may be a cathode, and the second catalyst electrode 230 may be an anode.

Next, in the modified example of FIG. 6, gas diffusion layers 241 and 242 are further provided outside of the catalyst electrodes 210 and 230, respectively, and FIG. 7 illustrates an enlarged view of one region B of the gas diffusion layer. Specifically, a first gas diffusion layer 241 disposed below the first catalyst electrode 210 and a second gas diffusion layer 242 disposed above the second catalyst electrode 230 are further provided. These gas diffusion layers 241 and 242 may be implemented as a porous transport layer (PTL), and may have excellent durability and efficiency even at high current operating density. The gas diffusion layers 241 and 242 may discharge oxygen bubbles within a stack of the water electrolysis cell, and may allow the electrolyte to easily penetrate a surface of the electrode, and serve to conduct electricity between the electrode and the separator. In order to perform this function, as an example, the first gas diffusion layer 241 may include fibers 260 based on a material such as titanium (Ti), and in addition thereto, the first gas diffusion layer 241 may also be implemented in the form of felt, mesh, sintered powder, and the like. As an example, the second gas diffusion layer 241 may be implemented using carbon fiber and may have a similar shape to the first gas diffusion layer 241.

A first spacer 251 may be disposed between the polymer electrolyte membrane 220 and the first gas diffusion layer 241 to surround the first catalyst electrode 210, and a second spacer 252 may be disposed between the polymer electrolyte membrane 220 and the second gas diffusion layer 242 to surround the second catalyst electrode 230. The first and second spacers 251 and 252 may function as gaskets preventing leakage of gas, or the like, and may be formed using polymer materials that can be used in the art.

Examples of specific embodiments of the method of producing a catalyst for a membrane-electrode assembly described above will be described below. Example 1 illustrates a method of preparing aggregates of catalyst particles, and Example 2 illustrates a method of preparing catalyst particles supported on a support.

### Example 1

### (1) Preparing an Ir Precursor

1) 2.5 g of IrCl₃·nH₂O was dispensed into a 100 ml vial and dissolved in 100 ml of ultrapure water (DI water).

2) A stirring bar was inserted into the vial and stirred for 2 hours. In this case, a stirring speed was 650 rpm.

3) After 2 hours of stirring, the solution was treated with sonication for 30 minutes to be completely dissolved.

### (2) Preparing a Reducing Agent (NaBH₄)

1) A weight of the reducing agent, equal to three times the number of moles of an Ir precursor, was dispensed into a 100 ml vial, and dissolved in 50 ml of ultrapure water.

2) A reducing agent was weighed using a proportional formula of 298.58 g (mass of 1 mole of an IrCl₃·nH₂O precursor): 1 mole=2.5 g: x mole.

3) To minimize the generation of H₂ gas, NaBH₄ was dissolved in 50 ml of ultrapure water in an ice bath.

### (3) Transferring an Ir Precursor and Injecting a Reducing Agent

1) 100 ml of the Ir precursor solution was transferred to a 2 L 3-necked flask, and 400 ml of ultrapure water was added.

2) An ice bath was prepared to lower a temperature of the three-necked flask (stirring speed 650 rpm).

3) A reducing agent solution was slowly injected dropwise into the three-necked flask.

### (4) Synthesis Solution Aging and Reaction Progress

1) A reducing agent was injected into an ice bath, and then reacted at room temperature (25° C.) for 2 days (48 h) (maintaining stirring at 650 rpm).

2) An oil bath was preheated to 120° C. to prevent the temperature from dropping rapidly when a high-capacity flask was added.

3) A three-necked flask was transferred to the preheated oil bath, and the temperature decreased by about 20 to 30° C. It reacted at 95° C. for 2 hours from the time the flask was transferred.

(5) Cleaning and Purifying a Catalyst Solution after Completion of Synthesis was Undertaken.

1) Ultrapure water and acetone were added, and a catalyst was precipitated and separated from a synthesis solution using a centrifuge.

2) After the separation, the catalyst was dispersed in ultrapure water to manufacture a catalyst dispersion.

### Example 2

### (1) Preparing an ATO Dispersion

1) 1.35 g of Antimony Tin Oxide (ATO) was dispensed into a 100 ml vial and was dispersed in 75 ml of ultrapure water.

2) A dispersion was sonicated for 1 hour and transferred to a 2 L three-necked flask.

3) 175 ml of ultrapure water was added to the flask, and the amount was adjusted to a total of 250 ml, and stirred at 650 rpm.

### (6) Preparing an Ir Precursor

1) 2.5 g of IrCl₃·nH₂O was dispensed into a 100 ml vial and dissolved in 100 ml of ultrapure water (DI water).

2) A stirring bar was inserted into the vial and stirred for 2 hours. In this case, a stirring speed was 650 rpm.

3) After 2 hours of stirring, the solution was treated with sonication for 30 minutes to be completely dissolved.

### Preparing a Reducing Agent (NaBH₄)

1) A weight of a reducing agent, equal to three times the number of moles of Ir precursor, was dispensed into a 100 ml vial and dissolved in 50 ml of ultrapure water.

2) The reducing agent was weighed using a proportional formula of 298.58 g (mass of 1 mole of IrCl₃·nH₂O precursor): 1 mole=2.5 g: x mole.

3) To minimize the generation of H₂ gas, NaBH₄ was dissolved in 50 ml of ultrapure in an ice bath.

### (4) Transferring an Ir Precursor and Injecting a Reducing Agent

1) 100 ml of an Ir precursor solution was transferred to a flask in which an ATO support for supporting a catalyst was dispersed and 150 ml of ultrapure water was added.

2) An ice bath was prepared to lower a temperature of the flask (stirring speed 650 rpm).

3) A reducing agent solution was slowly injected dropwise into the three-necked flask.

The subsequent process was the same as Example 1 above.

As set forth above, according to an example of the present disclosure, through the method of producing a catalyst for a membrane-electrode assembly, catalyst particles having a uniform and fine size may be obtained, and the performance of the membrane-electrode assembly including such a catalyst may be improved.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While example embodiments have been shown and described above, it will be apparent to those skilled in the art that modifications and variations could be made without departing from the scope of the present disclosure as defined by the appended claims.

What is claimed is:

1. A method of producing a catalyst for a membrane-electrode assembly, comprising:
preparing a precursor solution including a catalyst metal;
preparing a seed solution by maintaining the precursor solution at a temperature within a first temperature range, which is lower than room temperature;
preparing the seed solution at a temperature within a second temperature range, which is higher than the first temperature range; and
heating the seed solution to a temperature within a third temperature range, which is higher than the second temperature range.

2. The method of producing a catalyst for a membrane-electrode assembly of claim 1, wherein the precursor solution comprises ions of the catalyst metal.

3. The method of producing a catalyst for a membrane-electrode assembly of claim 1, wherein the first temperature range is 0° C. to 10° C.

4. The method of producing a catalyst for a membrane-electrode assembly of claim 1, wherein the maintaining the precursor solution in the first temperature range comprises adding a reducing agent to the precursor solution.

5. The method of producing a catalyst for a membrane-electrode assembly of claim 4, wherein the reducing agent comprises at least one selected from the group consisting of NaBH₄, ascorbic acid, and hydrazine.

6. The method of producing a catalyst for a membrane-electrode assembly of claim 4, wherein the adding the reducing agent to the precursor solution comprises injecting the reducing agent into the precursor solution at an amount of 0.1 ml/min to 20 ml/min.

7. The method of producing a catalyst for a membrane-electrode assembly of claim 1, wherein the second temperature range is 20° C. to 30° C.

8. The method of producing a catalyst for a membrane-electrode assembly of claim 1, wherein the maintaining the seed solution in the second temperature range is performed for 1 hour to 72 hours.

9. The method of producing a catalyst for a membrane-electrode assembly of claim 1, wherein the third temperature range is 40° C. to 120° C.

10. The method of producing a catalyst for a membrane-electrode assembly of claim 1, wherein during the heating the seed solution to the third temperature range, aggregates of nano-sized particles including the catalyst metal are formed.

11. The method of producing a catalyst for a membrane-electrode assembly of claim 10, wherein the nano-sized particles include an oxide of the catalyst metal.

12. The method of producing a catalyst for a membrane-electrode assembly of claim 10, wherein the nano-sized particles comprise particles having a diameter of 1 to 3 nm.

13. The method of producing a catalyst for a membrane-electrode assembly of claim 1, wherein the catalyst metal comprises at least one of at least one selected from the group consisting of Ir, Ru, Pt, Pd, Au, and combinations thereof.

14. The method of producing a catalyst for a membrane-electrode assembly of claim 1, wherein the manufacturing the precursor solution comprises dispersing a support for supporting the catalyst in the precursor solution.

15. The method of producing a catalyst for a membrane-electrode assembly of claim 14, wherein the support comprises at least one selected from the group consisting of Antimony Tin Oxide (ATO), Indium Tin Oxide (ITO), Fluorine doped Tin Oxide (FTO) TiO₂, Ti₃O₇, CeO₂, Carbon Black, Carbon Nanotube (CNT), Graphene flake, Graphene Oxide (GO), and Reduced Graphene Oxide (RGO) Ti₃O₇.

16. A membrane-electrode assembly, comprising a first catalyst electrode, a polymer electrolyte membrane disposed on the first catalyst, and a second catalyst electrode disposed on the polymer electrolyte,
wherein the first catalyst electrode includes the first catalyst produced by the method according to claim 1, and a first ion conductor,
the second catalyst electrode includes a second catalyst and a second ion conductor,
the second catalyst includes at least one selected from the group consisting of platinum (Pt), gold (Au), ruthenium (Ru), osmium (Os), palladium (Pd), and alloys thereof.

17. The membrane-electrode assembly according to claim 16, wherein the second catalyst is in a form of being supported on a support.

18. The membrane-electrode assembly according to claim 16, further comprising gas diffusion layers disposed under the first catalyst electrode and on a top of the second catalyst electrode.

19. The membrane-electrode assembly according to claim 16, wherein the gas diffusion layers include fibers.
